(19) United States
(12) Patent Application Publication
(10) Pub. No.: US 2011/0125607 A1
(43) Pub. Date: May 26, 2011

(54) Multi-pack gift card system and methods

(76) Inventor: Richard Wilen, Boca Raton, FL (US)

(21) Appl. No.: 12/873,031

(22) Filed: Aug. 31, 2010

Related U.S. Application Data
(63) Continuation-in-part of application No. 12/464,740, filed on May 12, 2009.
(60) Provisional application No. 61/238,575, filed on Aug. 31, 2009.

(51) Int. Cl. G06Q 30/00; G06Q 90/00

(52) U.S. Cl. 705/26.5; 705/500; 705/27.1

(57) ABSTRACT

Gift card distribution systems and methods are described for distributing a card issuer's or a plurality of card issuer's gift cards to consumers who are potential gift givers. The gift cards can be contained within a gift card multi-pack that features a plurality of gift card packages. Each gift card package can feature one of the gift cards, a mailing envelope, a greeting card, and an instruction sheet. The gift card package may also feature an advertisement. The gift giver can then mail or deliver one of the gift cards as well as other components of the gift card package to a gift recipient. The gift card multi-pack can include several shrink-wrapped gift card packages that can be mailed to a gift giver inside of a first class postage billing envelope.

### CROSS-REFERENCE TO RELATED APPLICATION

This application is a nonprovisional application of and claims priority from U.S. provisional patent application Ser. No. 61/238,575 filed on Aug. 31, 2009, and is a continuation-in-part application of U.S. nonprovisional patent application Ser. No. 12/464,740 filed on May 12, 2009. The foregoing applications are incorporated in their entirety herein by this reference.

### FIELD OF THE INVENTION

The invention relates to gift card distribution. More particularly, the invention relates to systems and methods for creating and distributing gift cards to gift givers for gifting to gift recipients.

### BACKGROUND

Gift card sales and usage have surged in recent years as consumers have been lured to the ease of use and flexibility that such gifting means provide. The conventional distribution of gift cards has been accomplished by passive means in which a consumer has been able to choose to obtain a gift card directly from a retail location by visiting a store or by ordering the gift card via telephone, e-mail, or the internet. The conventional method of acquiring a gift card generally requires the consumer to take some action to obtain the physical gift card, whether the action be traveling to and visiting a retail location or accessing a retailer's website to order the gift card, traditional gift card issuers have failed to capture a large segment of the potential gift card market due to these passive sales techniques. Some gift card issuers have turned to “gift card mall” companies that place displays in certain heavily trafficked retail locations, e.g., grocery stores or large department stores, which contain gift cards issued by multiple retailers and manufacturers. For example, a consumer shopping at a grocery store having a gift card mall display may be able to purchase and fund a gift card obtained from that gift card mall display in the grocery store where the gift card is selected from among a book retailer, a sporting goods retailer, a clothing retailer, and a jewelry retailer, all of whom have no connection to the grocery store other than that their gift cards are sold at the gift card mall display located therein. Thus, the conventional systems and methods for distributing and selling gift cards are disadvantageous due to their reliance on the customer to take action to seek out and obtain the gift card.

Conventional gift card marketing is generally passive and relies primarily on brand recognition and gift card availability at the time of purchase by the gift giver. As gift cards have become a major product category with significant financial and monetary implications to card issuers, distribution and gift card product marketing has not expanded at the same rate. As a result, current gift card marketing and distribution systems continue with little or no change from those used for decades.

### SUMMARY

The invention relates to systems and methods for creating and distributing gift cards. The system can include a gift card multi-pack that features packages of gift cards, greeting cards and envelopes that assist a consumer in activating and purchasing gifts using the Internet. The system can include all the items needed to send the gift card, greeting card and envelope to the gift recipient conveniently from the comfort of the consumer's home or office. The packages of gift cards, greeting cards and envelopes can be inserted into envelopes, a shrink-wrapped, wrapped in a poly-bag, boxed or placed into any suitable packaging that contains multiple gift card packages for distribution. Each gift card package included in the gift card multi-pack can include a gift card, a greeting card, an envelope for mailing the gift card and greeting card, and/or at least one instruction sheet providing instructions for activating, funding, and redeeming the gift cards. The gift card multi-pack may contain 2, 3, 4, 5, 6, 7, 8, 9, 10, 15, 20, 25, 30, 40, 50, 75, 100, 150, 200, or more gift cards, or any other intervening number of gift cards. The gift cards included in each gift card multi-pack can be provided by the same card issuer or by a plurality of different card issuers.

The system can further include a website and/or a telephone system for use by a gift giver to activate and fund one of the gift cards selected from the gift card multi-pack for gifting to a gift recipient

The method of distributing gift cards can feature the steps of packaging a plurality of gift card packages to form a gift card multi-pack that can be inserted into billing envelope sent another company such as, for example, a cable television bill mailed by a cable company. In another embodiment, the gift card multi-pack can be attached to a product or product package sold by a company and may contain gift cards issued by non-competing advertisers.

The method of creating gift cards and gift card packages can utilize blank forms or templates that can be personalized by a gift giver prior to mailing to a gift recipient and printed by the gift giver using a home or office desktop printer or any other suitable printing device. The gift card form can feature perforations or other lines of separation that separate components that include a gift card, a greeting card, an envelope, and an instruction sheet. After printing, the gift giver can separate these detachable components from the form blank, assemble the envelope, and mail the activated and funded gift card along with the greeting card and instruction sheet inside the envelope to the gift recipient.

The gift card distribution systems and methods of the invention are advantageous because they use active, rather than passive, advertising that places a plurality of gift cards directly into consumers' homes and hands rather than relying upon the consumers, i.e., the potential gift givers, to visit a retail location or website to order or purchase and fund gift cards. The gift card multi-pack can be expected to achieve a higher rate of usage among consumers because consumers are not required to take action to obtain the gift card, but instead, the gift card is sent to the consumers either solicited or unsolicited.

Another advantage of the gift card distribution systems and methods is that the consumer is able to receive a “gift card mall” in the home rather than being required to travel to a retail location such as a grocery store, department store, or to the card issuer's own store to obtain and fund a gift card. The consumer can be provided a broad selection of gift cards from a variety of different retailers or service providers through the direct mailing of a gift card multi-pack or through the inclusion of a gift card multi-pack in another company's billing envelope.

Still another advantage of the multi-pack gift card system is that it can be delivered directly to a user's home, solicited or unsolicited, which can increase spending and usage of the gift card component, as opposed to relying upon the user to visit a retail location having a gift card mall to purchase and fund a gift card.

Yet another advantage of the multi-pack gift card system is that it may be constructed so as to be flat and of a uniform or nearly uniform thickness so that when a plurality of the multi-purpose forms are packaged, the packaged forms comply with United States Postal Service or other mailing or courier service guidelines and regulations related to the required flatness of printed materials being mailed.

Yet another advantage of the gift card multi-pack is that paper gift cards may be used, which are safer to mail than plastic cards due to their narrow thickness that cannot easily be felt through a closed envelope as opposed to thicker plastic cards that are easily recognized by touching the surfaces of a closed envelope. As an additional safety feature, a website of the systems described herein can be used to register a gift card to its intended recipient so that only the intended recipient can redeem the gift card using a login, password, or other information that can be used to confirm the recipient's identity through the website.

The gift card creation and distribution systems and methods of the invention are also advantageous in that the gift giver is allowed to personalize the gift card and other components of the gift card package (e.g., the greeting card and envelope) using a home or office printer. The gift giver may use these systems and methods to include personalized printed text or images on the gift card package components using the above-described printed forms.

Accordingly, the invention features a gift card distribution system that can include a gift card multi-pack. The gift card multi-pack may feature a plurality of gift card packages. Each gift card package can include a gift card, an envelope, and a greeting card.

In another aspect, the invention can feature each gift card package further including a coupon.

In another aspect, the invention can feature the coupon being redeemable for a discount that is applied to the purchase price of a good or service purchased by a user from an issuer of the gift card.

In another aspect, the invention can feature the system further including a carrier to which the gift card multi-pack is attachable.

In another aspect, the invention can feature the carrier being an item selected from the group among the following items: a product package for a good, a publication, a food container, a beverage container, a shopping bag, or a mailing envelope sized and shaped to contain the gift card multi-pack.

In another aspect, the invention can feature the carrier being a marriage mail piece.

In another aspect, the invention can feature the marriage mail piece being a billing envelope also containing an invoice, a bank statement envelope also containing a bank statement, or a mailing envelope for a mail item other than the gift card multi-pack.

In another aspect, the invention can feature a website that is accessible via a computer connected to a communications network. The gift card can be activated, funded, and redeemed by a user using the website. The user can be a gift giver and a gift recipient.

In another aspect, the invention can feature each gift card package including a plurality of forms each of which includes lines of separation at which the gift card, envelope, and greeting card are detachable from the form.

The invention also features a method for distributing gift cards. The method can include the steps of (a) creating a gift card multi-pack; (b) attaching the gift card multi-pack to a carrier; and (c) delivering the gift card multi-pack to a gift giver by delivering the carrier to the gift giver.

Another method of the invention can feature the step of attaching the gift card multi-pack to the carrier including the step of inserting the gift card multi-pack into a billing envelope containing an invoice. The billing envelope can be the carrier.

Another method of the invention can feature the step of attaching the gift card multi-pack to the carrier including the step of inserting the gift card multi-pack inside of a shopping bag handed to a gift giver at a sales checkout counter when the gift giver purchases an item.

Another method of the invention can feature the step of attaching the gift card multi-pack to the carrier including the step of inserting the gift card multi-pack inside a fulfillment box being delivered to the gift giver.

Another method of the invention can feature the step of attaching the gift card multi-pack to the carrier including the step of inserting the gift card multi-pack into a publication.

Another method of the invention can feature the publication being a magazine, a newspaper, or a catalog.

Another method of the invention can feature the carrier being a direct mail envelope or package sized and shaped for containing the gift card multi-pack.

Another method of the invention can feature the carrier being a marriage mail envelope or package containing a first article being mailed and into which the gift card multi-pack is also inserted.

Another method of the invention can feature the gift card multi-pack including a plurality of forms capable of being stacked to produce a flat package for mailing.

Another method of the invention can feature the gift card multi-pack including a plurality of gift card packages, each of which can include a gift card, an envelope, and a greeting card.

The invention also features a method for creating a gift card package. The method includes the step of (a) providing a printable form that can be personalized by a gift giver. The form can feature the following detachable components: a gift card, a greeting card, and an envelope. In step (b) of the method, a system can be provided that is accessible to the gift giver via a website using a computer connected to the Internet. In step (c) of the method, the gift card can be activated and funded through the website, and in step (d), following activation and funding of the gift card, a gift card number can be obtained for printing on the gift card. In step (e), the gift giver can use the system website to input personalized content for printing onto the form. In steps (f) and (g), the personalized content and the gift card number can be printed onto the form, and the detachable components can be detached from the form. Finally, in step (h), the gift card and greeting card can be inserted into the envelope for mailing to a gift recipient.

Another method of the invention can feature the step of providing a printable form further including the step of packaging a plurality of the printable forms to create a gift card multi-pack.

Another method of the invention can feature the step of delivering the gift card multi-pack to the gift giver by attaching the gift card multi-pack to a carrier that is being delivered to the gift giver for reasons independent of the delivery of the gift card multi-pack.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a gift card multi-pack gift.

FIG. 2 is a rear view of the gift card multi-pack inserted into a pocket of an envelope.

FIG. 3 is a front view of a gift card package form.

FIG. 4 is a rear view of the gift card package form of FIG. 3.

FIG. 5 is an elevational view of an interior of a gift card package of the gift card multi-pack of FIG. 1 showing a greeting card inserted into a pocket of an envelope and a gift card and a coupon detachably connected to a lid of the envelope.

FIG. 6 is an elevational view of an exterior of the gift card package of FIG. 5 showing reverse sides of the envelope, gift card, and coupon.

### DETAILED DESCRIPTION

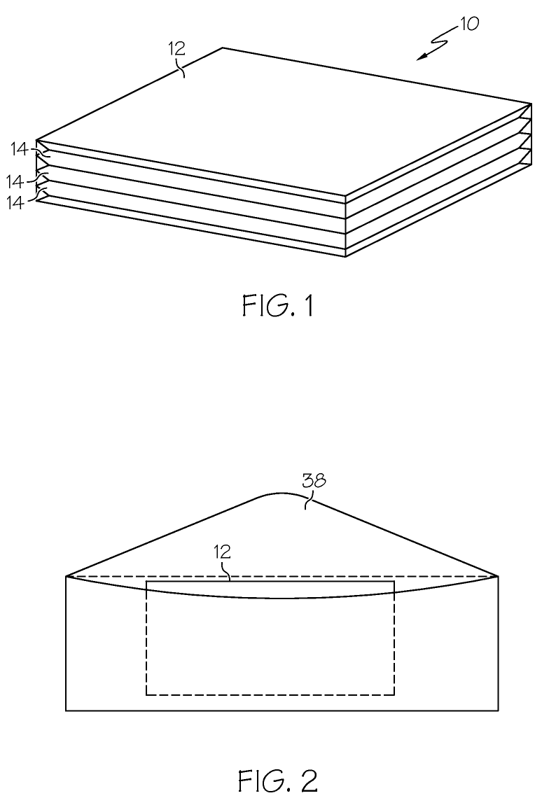

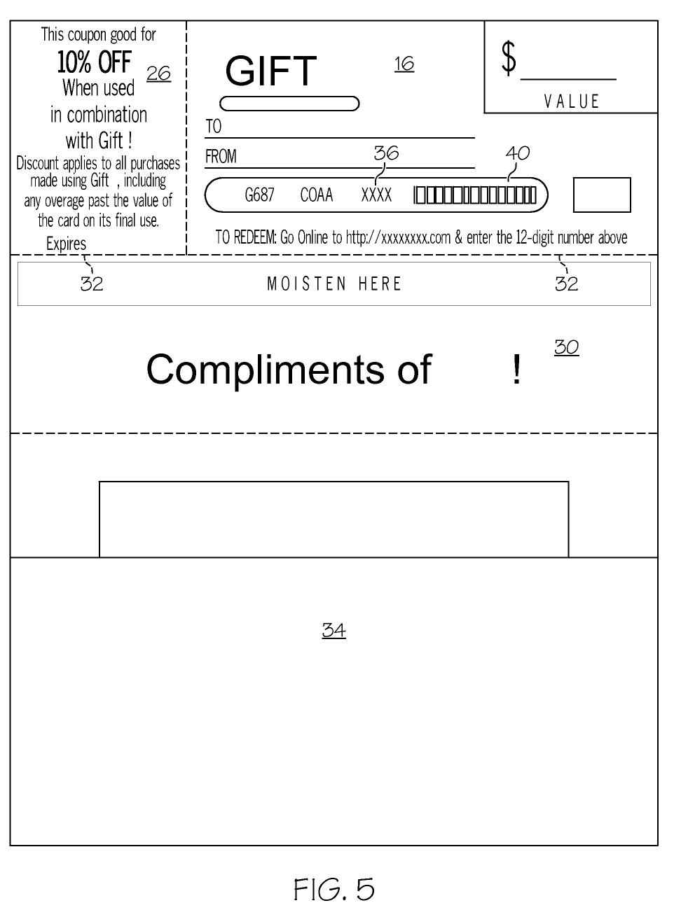

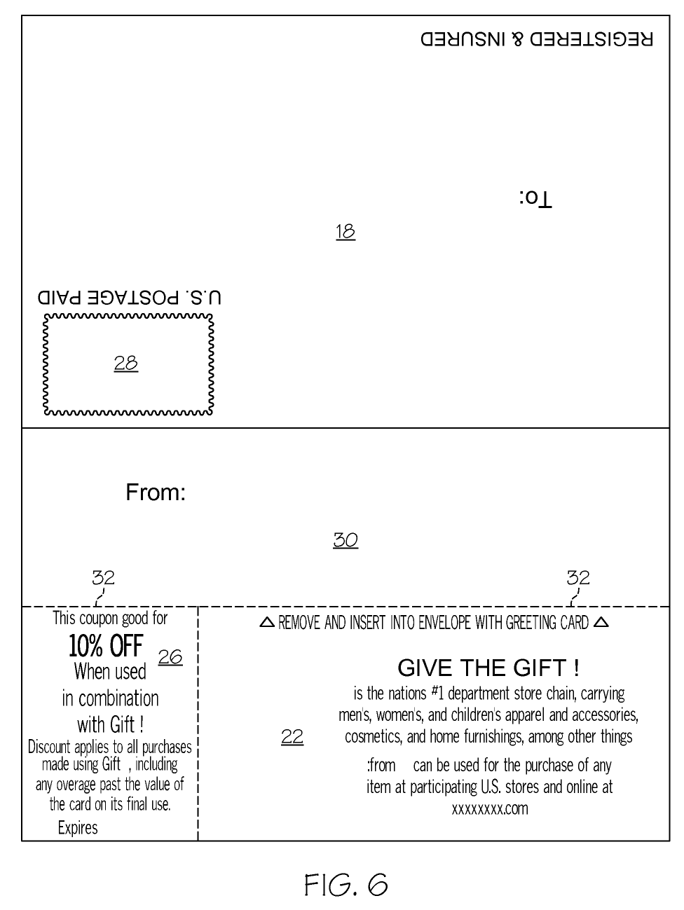

The invention provides gift card distribution systems and methods as well as systems and methods for creating the gift cards that are to be distributed. According to FIG. 1, the gift card distribution system can include a package containing multiple gift cards (hereinafter referred to as a gift card multi-pack) that can be distributed directly to a consumer (e.g., a gift giver). The gift card multi-pack can include a plurality of gift cards each of which is issued by a different retailer or manufacturer or by the same retailer or manufacturer. Retailers and manufacturers may be referred to hereinafter as gift card issuers. Each of the plurality of gift cards contained in the gift card multi-pack can be separately wrapped or packaged into a gift card package. In addition to a gift card, the gift card package can further include one or more of a mailing envelope, a greeting card, an advertisement, and an instruction sheet. As shown in FIGS. 5 and 6, the gift card package may also include a coupon that can be used by the gift giver or by a gift recipient to obtain a discount on products purchased as gifts by the gift giver or products purchased by the gift recipient when redeeming the gift card.

In an exemplary embodiment, the gift card distribution system can further include a website that is accessible from a computer via the Internet, which can be accessed and utilized by a gift giver to activate and fund a gift card prior to sending the gift card to the gift recipient. The gift giver can provide personal identification (e.g., name, address, telephone number, user name, and/or password) and payment information (e.g., credit card or checking account numbers and other information) to activate and fund the gift card. In other embodiments, the gift giver can activate and fund one or more gift cards from the gift card multi-pack by a telephone access system, at a retail location, at a gift card kiosk, or via mail.

The gift card of the gift card package can be a conventional standard-sized gift card or may be larger or smaller than conventional gift cards. In an exemplary embodiment, the gift card can be constructed from paper. In other embodiments, the gift card can be constructed from plastic or other suitable materials.

The mailing envelope of the gift card package can be sized and shaped to meet any rules or regulations for mailing in the United States or in foreign jurisdictions. The mailing envelope can include indicia concerning the location for the affixation of postage. A lid of the envelope can include the gift card, which can be detachable from one edge of the lid. The envelope lid may also include the coupon, which can also be detached from an edge of the lid. The mailing envelope can include a pocket that is sized to hold only the gift card. In another embodiment, the pocket of the mailing envelope can have dimensions that permit it to hold other items such as, for example, more than one gift card or a greeting card in addition to the gift card. The gift card can be detached from the lid by the gift giver and inserted into the pocket of the envelope along with the greeting card. The greeting card can be used by the gift giver to send a personalized message, e.g., a written or typed message, to the gift recipient along with the gift card.

The advertisement can be included in the gift card package to permit the gift card issuer to advertise other products or services of the gift card issuer to the gift giver or to the gift recipient. The online activation system using the Internet can expand the advertising content viewed by a user by directing the gift giver and subsequently the gift recipient to advertisements, e.g., video commercials and photo slide shows. The advertisements viewed by the users can be personalized to each user by incorporating text-to-speech audio into the system and its advertisements. The gift card package can include more than one advertisement. In addition, the advertisement and online advertising can provide useful information to educate the gift giver and/or gift recipient concerning the card issuer's product or brand.

The instruction sheet can be included in the gift card package to provide information and instructions to the gift giver concerning the activation and funding of the gift card. Additionally, the invention includes the use of a hexadecimal numbering system that takes the user directly to specific retailer websites and micro-websites. The instruction sheet may also include information and instructions to the gift recipient concerning the redemption of the gift card. In this latter embodiment, the instruction sheet can be inserted into the pocket of the mailing envelope to be delivered to the gift recipient along with the gift card. The gift card package can include at least two separate instruction sheets: one for the gift giver and another for the gift recipient. A website of the system can also include web pages incorporating text-to-speech technology and one or more avatars that speak directly to the user to instruct the user how to use, activate and redeem the gift card. In another embodiment, the instruction sheet may include two sections (one directed to the gift giver and another directed to the gift recipient) that are detachable at a line of separation, e.g., a perforated line.

In one embodiment, each of the plurality of gift cards in the gift card multi-pack can be redeemable for a specific gift from the gift card issuer or may be redeemable for a gift that is selected for a gift recipient by the gift giver.

In another embodiment, each of the plurality of gift cards in the gift card multi-pack can include a discount gift card purchase option. With such an option, redemption of each card can be controlled so that the cards may redeemed only at the manufacturer or distributor card issuers' participating retailers and/or for specific products at those same participating retailers.

In an exemplary embodiment, the gift giver can select a gift card in the gift card multi-pack issued by one gift card issuer and can fund the selected gift card with an amount of money chosen by the gift giver. The funded gift card can then be mailed or otherwise delivered by the gift giver to the gift recipient. The remaining gift cards in the gift card multi-pack can be retained by the gift giver for later use in making gifts to the same or other gift recipients.

In one exemplary embodiment, the gift card multi-pack can include five gift card packages. The gift card multi-pack that contains five gift card packages can be constructed to weight no more than one ounce. Other embodiments of the gift card multi-pack may feature more or fewer gift card packages. Regardless of the number, the gift card packages may be manufactured and printed in full color using an in-line printing press. Each set of gift card packages to be included in a gift card multi-pack can be shrink-wrapped together for easy mailing and delivery. As shown in FIG. 2, the gift card multi-pack can also be designed in a shape and size that makes it capable of insertion into a billing envelope or other envelope. The size and shape of a five-count gift card multi-pack permits insertion into an envelope using only one pocket or stacker per each gift card multi-pack on existing inserting machines.

In another embodiment, the gifting system may use a multi-pack, which can be a package or envelope containing multiple gift cards for a plurality of products or services or from a plurality of retailers or manufacturers. The multi-pack can be delivered to the consumer, e.g., by direct mail, so that the consumer can browse the gift cards and select one or more to activate and fund for gifting to a giftee. The giftor's opportunity to select one or more gift cards for activation and gifting to a giftee from among the plurality of gift cards contained by the multi-pack provides a type of “gift card mall” experience that is delivered directly to the giftor's home. The giftor can select a gift from among the gift representations provided in the multi-pack and activate and fund the gift card via the website from a location and computer that is convenient for the giftor. The multi-pack can be mailed to a consumer upon the consumer's request or can be mailed to a group of consumers whose contact information is obtained from a mailing list compiled or acquired by the card issuer or advertiser.

In one exemplary embodiment, the gift card multi-pack can be packaged for Flat Rate Standard Mail in accordance with the United States Postal Service (“USPS”) Direct Mail Manual specifications and regulations for USPS Flat Rate Standard Mail. To comply with USPS regulations and specifications applicable to USPS Flat Rate Standard Mail, the package of multi-purpose forms can be a minimum of about 6 inches wide×5 inches long with about 0.125-inch radius rounded corners and the packaged multi-purpose forms can be no more than about 0.75 inches in thickness from any edge of the package. The package of gift card multi-pack is flexible so that the package is capable of bending one inch from any edge without affecting the contents inside the package. By definition the gift card multi-packs and the resulting packages will be a uniform thickness so that there will not be any bumps, protrusions, or other irregularities do not cause more than one-quarter of an inch in variance in the thickness of the package. The finished sheet dimensions and packaging fall within the USPS Flat Rate Standard Mail requirements which will minimize the postage expense for mailing each package of gift card multi-packs.

In another exemplary embodiment of the system, the gift card multi-pack can feature a shrink-wrapped stack of 10 to 100 gift card packages. In other embodiments, the gift card multi-pack can include two or more shrink-wrapped stacks of gift card packages, and the number of gift card packages contained in the gift card multi-pack can be fewer or more than 100. This embodiment of the gift card multi-pack can be direct mailed to consumers in a fixed rate package such as, for example, the U.S. Postal Service's fixed rate Priority Mail Pack.

A gift card distribution method of the invention can feature the above-described gift card multi-pack being inserted into a first class postage envelope, for example, a first class postage billing envelope for any company that mails invoices. For example, a gift card multi-pack containing five shrink-wrapped gift card packages can be inserted into a billing envelope containing an invoice mailed by a cable company, a power company, a phone company, or a credit card company. The five-count gift card multi-pack can include gift cards manufactured from paper and, when shrink-wrapped, can be less than one-eighth of an inch thick. In other embodiments, the five-count gift card multi-pack can be 1/16, 1/10, ⅕, ¼, ⅓, ½, or 1 inch in thickness when shrink-wrapped.

In another embodiment, the gift card multi-pack can be inserted into a bank statement envelope or into a billing envelope as “marriage mail,” i.e., a second article delivered along with a first article where the first article is the primary reason for the mailing. Marriage mail is itself a type of direct mail. In still another embodiment, the gift card multi-pack can be shrink-wrapped with a magazine that is mailed to a gift giver as part of a monthly subscription. In another embodiment, the gift card multi-pack can be attached to a pizza box tops or other product packaging surfaces such as to the surface of a fulfillment box in which another product ordered by the user is being shipped to the user, inserted into a shopping bags, handed out at restaurants as part of the checkout procedure, inserted into publications, or direct mailed or marriage mailed. Using any of the aforementioned means of distribution, the gift giver receiving the gift card multi-pack can then select one or more gift card packages for activation and funding to be mailed or otherwise delivered to one or more gift recipients.

In embodiments in which the gift card multi-pack is direct mailed or included in marriage mail, the low weight of the gift card multi-pack will add very little to the cost of mailing by taking advantage of the current U.S. Postal Service rates for mail items weighing between 1-2 ounces. For example, in marriage mail embodiments, the first ounce of postage currently costs 44 cents while the second ounce costs an additional 12.5 cents. The first article, for example, a first class postage billing envelope and invoice, whose deliver is the primary purpose for the mailing, automatically costs 44 cents as the first ounce of postage under current U.S. Postal Service rates. Inserting a gift card multi-pack featuring five shrink-wrapped gift card packages into the billing envelope as marriage mail adds an additional ounce to the weight of the mailing. The additional weight of the gift card multi-pack within the billing envelope would add only 12.5 cents (or 2.5 cents per gift card package) to the postage cost by utilizing current U.S. Postal Service rates. A second five-count gift card multi-pack can easily and inexpensively be inserted into a billing envelope for only an additional 12.5 cents as long as the total weight of the billing envelope and contents remains under two ounces pursuant to current U.S. Postal Service weight and postage rates and regulations. If the first article weighs less than one ounce, practicing the invention, it is possible to create a gift card multi-pack that together with the first article and envelope will not exceed one ounce in weight so that the marriage mail postage will be the then-current first class rate for mail weighing one ounce or less, thereby avoiding the additional charge for exceeding one ounce.

In another embodiment, rather than being inserted into an envelope for mailing, the gift card multi-pack can be encased in a wrapper, e.g., a paper, plastic or foil wrapper. The gift card multi-pack form can be manufactured as a single leaf or as multiple leafs from paper or another substrate of any weight. Each gift card multi-pack form can also include a single page or multiple pages. The lighter the substrate from which the gift card multi-pack is constructed, the more gift card multi-pack forms that can be included in each gift card package so as not to exceed the one ounce postage standards.

In embodiments of the method in which the gift card multi-pack is attached to another product or product package such as, for example, to a top of a pizza box, the retailer or manufacturer of the other product or product package could be allowed to include one or more free or allowed gift card packages for its own products in the gift card multi-pack while allowing the other included gift cards to be issued only by non-competing advertisers (i.e., non-competing retailers or manufacturers).

The gift card multi-pack can be attached to the box or other packaging by a magna-strip or other resins or glues, although any suitable attachment means may be used for the purpose. Magna-strips may also be utilized to attach the gift card multi-packs inside, on, and to magazines and other publications.

The multi-pack and the plurality of individually unique gift cards contained therein can be manufactured using a single stream in-line process, by a sheet-fed operation, manually, or by any other suitable printing and folding means. In an exemplary embodiment, to efficiently create the multi-pack, a variable printing machine may be used to print unique gift cards sequentially via inkjet printing means. The sequential printing feature of the variable printing machine allows a single set of a plurality of unique gift cards, e.g., gift cards for a plurality of different gifts or from a plurality of different retailers or manufacturers, to be printed as one sequential set that can be packaged together rather than requiring printing and subsequent collation of the different cards. The gift cards can be variably printed so that each card differs in the name of the consumer, the gift representation, the retailer, or the manufacturer printed on each card in the set that is to be packaged. In this way, each consumer can receive a multi-pack that is individually personalized for the specific user and which can contain gift cards that are the same as or different from those contained in any other multi-pack. Personalization of each multi-pack for each specific user can be accomplished using personal information contained in a database related to each user. The printing machine can collate the cards automatically rather than requiring each set of identical gift cards to be separately printed and subsequently collated by manual or mechanical means. In one embodiment, the multi-pack may also contain one or more mailable greeting cards and envelopes in addition to the plurality of gift cards. In another embodiment, the multi-pack can be made available for pick-up by giftors in a retail location. Each gift card in the multi-pack may include a unique hexadecimal number, standard gift card number, and/or bar code printed thereon. Other information can also be printed on each unique gift card within the multi-pack to further personalize the gift card such as, for example, the giftor's name and address, the product name or product image, and product information. Similar personalized data can be printed on the greeting card in embodiments in which the multi-pack contains one or more greeting cards.

Once a gift giver receives a gift card multi-pack, the gift giver can select one or more gift cards (each gift card being contained within one of the gift card packages enclosed in the gift card multi-pack) for activation and funding via the system's website or another available activation and funding method. After the selected gift card has been activated and funded, the gift card can be inserted into a mailing envelope of the gift card package and deposited into the mail for delivery to a gift recipient. In one embodiment, the gift giver may write a personal message to the gift recipient in a greeting card of the gift card package and enclose the greeting card with the gift card in the mailing envelope. In another embodiment, an instruction sheet of the gift card package can be inserted by the gift giver into the mailing envelope to provide instructions to the gift recipient concerning activation and redemption of the gift card.

The method can be used to deliver gift cards in gift card multi-packs to consumers (potential gift givers) at intervals as frequent as desired by the card issuers. For example, the gift card multi-packs can be delivered monthly, quarterly, or yearly, or only on special occasions such as, for example, a holiday or the gift giver's birthday. In an exemplary embodiment, the gift card multi-pack can be delivered to gift givers whose names and addresses are gathered from lists compiled by marketing firms and by data mining. In another embodiment, the gift card multi-pack can be delivered to the gift giver at the gift giver's request.

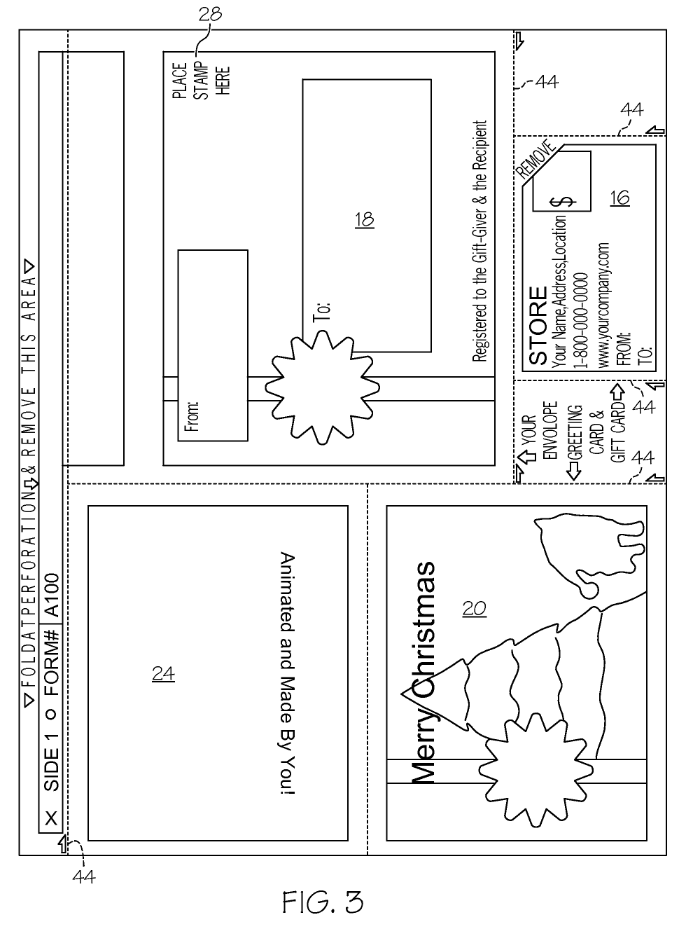

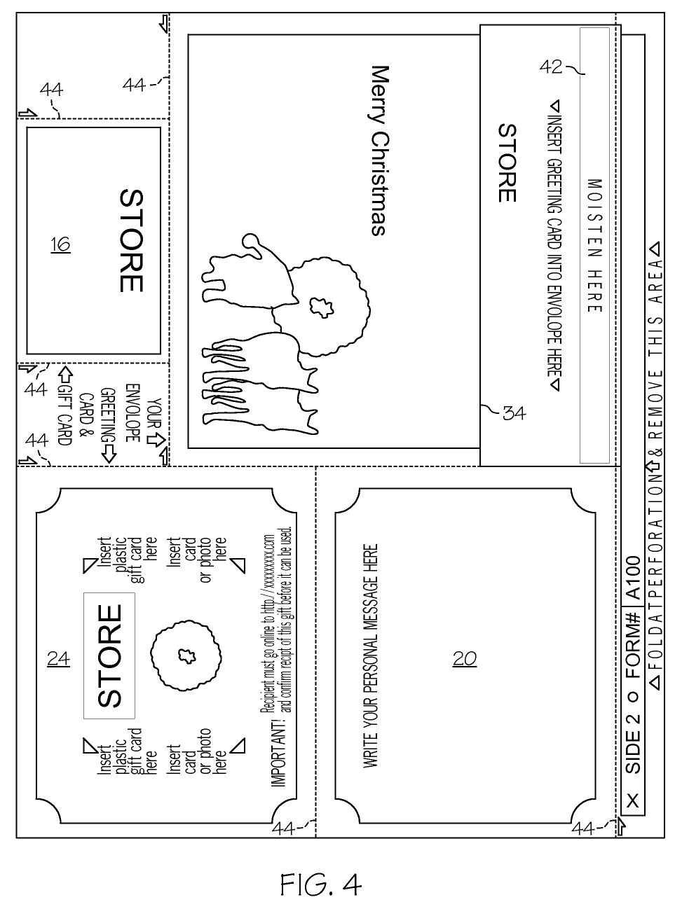

The invention also features methods for creating the gift card packages that are featured in the gift card multi-packs described herein. As shown in FIGS. 3 and 4, gift givers may obtain forms that can be printed using a home or office desktop inkjet printer to create personalized gift cards, envelopes, and greeting cards. The forms may be single-page or multi-page forms. The forms may include pre-installed glue or other adhesives for creating and sealing the envelope. The forms may also require folding by the gift giver to form the envelope once the form has been printed. The forms can further include lines of separation or perforations that permit the gift card, greeting card, and envelope to be separated (or punched out) from the form once the form blank has been printed. The forms may include certain pre-printed information provided by the gift card issuer or by the gift card system administrator. The gift giver may personalize the forms for printing using text or images supplied by the gift giver or the gift giver may access the website described herein to obtain free template text and/or images or to purchase similar material for personalizing the gift card package at the time of printing. Personalization of the form may be accomplished by the gift giver using a graphical user interface of the system's website or by utilizing software such as, for example, a plug-in for a word processing software program (e.g., WordPerfect or Microsoft Word). The gift card form can be designed for printing on both sides of the form, which can be accomplished using the website or the plug-in software.

Prior to printing, the gift giver can be required to activate and fund the gift card so as to obtain a gift card number that can be printed on the gift card. The gift card number can be a hexadecimal number or a conventional sixteen-digit number.

In an exemplary embodiment, the gift giver can be required to access and use the system website in order to activate and fund the gift card. Once the gift giver has activated and funded the gift card, the system can issue a gift card number for printing on the gift card and gift card personalization features of the system may be unlocked on the website for access and use by the gift giver.

In another embodiment, where the card issuer is a brick-and-mortar retailer, the giftee may redeem the card contained within the gift card multi-pack to receive the gift by visiting one of the retailer's store locations.

After the gift giver has completed personalization of the gift card form, the gift card form can be printed using the gift giver's home or office printer. The gift card, greeting card, and envelope components of the gift card form can be detached from the form by separating each of the components at the lines of separation or perforations. The gift giver can then fold the envelope making use of pre-installed adhesive sections where necessary. When the envelope has been formed by the gift giver, the gift giver can sign the greeting card, if desired, and insert the gift card and greeting card inside of the envelope. The envelope can then be sealed and postage affixed thereto for mailing to the gift recipient. In one embodiment, the form may also include an instruction sheet that can be detached and mailed to the gift recipient to inform the gift recipient how to activate and redeem the gift card.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A gift card distribution system comprising:
a gift card multi-pack, the gift card multi-pack comprising:
a plurality of gift card packages, each gift card package comprising:
a gift card;
an envelope; and
a greeting card.

2. The gift card distribution system of claim 1, wherein each gift card package further comprises a coupon.

3. The gift card distribution system of claim 2, wherein the coupon is redeemable for a discount that is applied to the purchase price of a good or service purchased by a user from an issuer of the gift card.

4. The gift card distribution system of claim 1, wherein the system further comprises a carrier to which the gift card multi-pack is attachable.

5. The gift card distribution system of claim 4, wherein the carrier comprises an item selected from the group consisting of: a product package for a good, a publication, a food container, a beverage container, a shopping bag, and a mailing envelope sized and shaped to contain the gift card multi-pack.

6. The gift card distribution system of claim 4, wherein the carrier comprises a marriage mail piece.

7. The gift card distribution system of claim 6, wherein the marriage mail piece comprises a billing envelope also containing an invoice, a bank statement envelope also containing a bank statement, or a mailing envelope for a mail item other than the gift card multi-pack.

8. The gift card distribution system of claim 1, further comprising a website accessible via a computer connected to a communications network, wherein the gift card can be activated, funded, and redeemed by a user using the website, wherein the user comprises a person selected from the group consisting of: a gift giver and a gift recipient.

9. The gift card distribution system of claim 1, wherein each gift card package comprises a plurality of forms, each of which comprises lines of separation at which the gift card, envelope, and greeting card are detachable from the form.

10. A method of distributing gift cards comprising the steps of:
(a) creating a gift card multi-pack;
(b) attaching the gift card multi-pack to a carrier; and
(c) delivering the gift card multi-pack to a gift giver by delivering the carrier to the gift giver.

11. The method of claim 10, wherein the step of attaching the gift card multi-pack to the carrier comprises inserting the gift card multi-pack into a billing envelope containing an invoice, wherein the billing envelope comprises the carrier.

12. The method of claim 10, wherein the step of attaching the gift card multi-pack to the carrier comprises inserting the gift card multi-pack inside of a shopping bag handed to a gift giver at a sales checkout counter when the gift giver purchases an item.

13. The method of claim 10, wherein the step of attaching the gift card multi-pack to the carrier comprises inserting the gift card multi-pack inside a fulfillment box being delivered to the gift giver.

14. The method of claim 10, wherein the step of attaching the gift card multi-pack to the carrier comprises inserting the gift card multi-pack into a publication.

15. The method of claim 14, wherein the publication comprises a magazine, a newspaper, or a catalog.

16. The method of claim 10, wherein the carrier is a direct mail envelope or package sized and shaped for containing the gift card multi-pack.

17. The method of claim 10, wherein the carrier is a marriage mail envelope or package containing a first article being mailed and into which the gift card multi-pack is also inserted.

18. The method of claim 10, wherein the gift card multi-pack comprises a plurality of forms capable of being stacked to produce a flat package for mailing.

19. The method of claim 10, wherein the gift card multi-pack comprises a plurality of gift card packages, each gift card package comprising: a gift card, an envelope, and a greeting card.

20. A method of creating a gift card package comprising the steps of:
(a) providing a printable form that can be personalized by a gift giver, wherein the form comprises the following detachable components: a gift card, a greeting card, and an envelope;
(b) providing a system that is accessible to the gift giver via a website using a computer connected to the Internet;
(c) activating and funding the gift card through the website;
(d) following activation and funding of the gift card, obtaining a gift card number that can be printed on the gift card;
(e) using the system website, allowing the gift giver to input personalized content for printing onto the form;
(f) printing the personalized content and the gift card number onto the form;
(g) detaching the detachable components from the form; and
(h) inserting the gift card and greeting card into the envelope for mailing to a gift recipient.

21. The method of claim 20, wherein the step of providing a printable form further comprises the steps of:
(i) packaging a plurality of the printable forms to create a gift card multi-pack; and
(j) delivering the gift card multi-pack to the gift giver by attaching the gift card multi-pack to a carrier that is being delivered to the gift giver for reasons independent of the delivery of the gift card multi-pack.
